(19) United States
(12) Patent Application Publication
(10) Pub. No.: US 2016/0126686 A1
(43) Pub. Date: May 5, 2016

(54) LED LIGHTING DISTRIBUTION UNIT AND COMPONENTS THEREOF

(71) Applicant: Anthony Sanders, Newton Aycliffe (GB)

(72) Inventor: Anthony Sanders, Newton Aycliffe (GB)

(21) Appl. No.: 14/436,506

(22) PCT Filed: Oct. 18, 2013
(86) PCT No.: PCT/GB2013/052722

§ 371 Date: Apr. 17, 2015

(30) Foreign Application Priority Data
Oct. 18, 2012 (GB) 1218765.4

(51) Int. Cl. H01R 25/00; H01R 4/18; H01R 4/48

(52) U.S. Cl. CPC H01R 25/00; H01R 4/4809; H01R 4/18

(57) ABSTRACT

A distribution unit for distributing mains electricity to multiple LED lighting devices, said unit comprising a terminal box and one or more plugs, the terminal box being adapted for connection to mains electricity and to receive said plugs, and each plug being adapted for connection to individual LED lighting elements, wherein said terminal box comprises: a) a housing having an opening for a distribution wire carrying mains electricity; b) a circuit board having terminals for connection of live and neutral conductors of said wire; c) at least two conductive tracks on the surface of said circuit board each connecting to a respective one of said terminals; and d) a plurality of sockets in the housing each having a non-circular bore with a longitudinal bore axis, the bore intersecting the edge of the circuit board, wherein said tracks are not closer than 3 mm to the edge of the circuit board where a socket intersects the circuit board, and wherein each said plug comprises: a) a body having a cross-section corresponding with the bore of each socket whereby the body can be inserted into the socket in only one orientation of the body with respect to the socket about said bore axis; b) a lighting wire for connection to an LED lighting element extending from the body; and c) a plug element on the end of the body and including two spring terminals, one connected to each of a live and neutral conductor of the lighting wire, wherein the plug element engages with the edge of the circuit board when the plug is inserted in a socket by movement along said axis and, on further movement of the plug into the socket by more than the distance of said tracks to the edge of the circuit board, said spring terminals engage a respective one of said tracks to complete electrical connection with the mains electricity.

This invention relates to an LED lighting distribution unit comprising a terminal box for connection to mains electricity and multiple sockets therein for reception of one or several plugs connected to LED lighting.

### BACKGROUND

LED lighting is more energy efficient than conventional mains lighting. For example, a 0.017 Amp LED can produce as much light as a 35W halogen lamp. Efficiencies in LED lighting make it desirable to place many lights about a room. Distribution of power to those lights is required.

Mains electricity is commonly distributed to a plurality of lights using a distribution unit having a plurality of sockets configured to accept terminals of plugs attached to wires extending to the lights. U.S. Pat. No. 7,950,941 describes an extension socket assembly that has a housing, a first conductive strip, a second conductive strip and sockets. The device is designed to distribute mains electricity and provide adequate displacement of the first and second conductive strips. However, the device is cumbersome.

It is an object of the present invention to improve upon the prior art arrangements.

### BRIEF SUMMARY OF THE DISCLOSURE

In accordance with the broadest aspect of the present invention there is provided a distribution unit for distributing mains electricity to multiple LED lighting devices, said unit comprising a terminal box and one or more plugs, the terminal box being adapted for connection to mains electricity and to receive said plugs, and each plug being adapted for connection to individual LED lighting elements, wherein said terminal box comprises:
a) a housing having an opening for a distribution wire carrying mains electricity;
b) a circuit board having terminals for connection of live and neutral conductors of said wire;
c) at least two conductive tracks on the surface of said circuit board each connecting to a respective one of said terminals; and
d) a plurality of sockets in the housing each having a non-circular bore with a longitudinal bore axis, the bore intersecting the edge of the circuit board, wherein said tracks are not closer than 3 mm to the edge of the circuit board where a socket intersects the circuit board, and wherein each said plug comprises:
a) a body having a cross-section corresponding with the bore of each socket whereby the body can be inserted into the socket in only one orientation of the body with respect to the socket about said bore axis;
b) a lighting wire for connection to an LED lighting element extending from the body; and
c) a plug element on the end of the body and including two spring terminals, one connected to each of a live and neutral conductor of the lighting wire,
wherein the plug element engages with the edge of the circuit board when the plug is inserted in a socket by movement along said axis and, on further movement of the plug into the socket by more than the distance of said tracks to the edge of the circuit board, said spring terminals engage a respective one of said tracks to complete electrical connection with the mains electricity.

Preferably, said live and neutral tracks are disposed on opposite sides of the board and said plug element includes a board slot to receive the edge of the board, said terminals being disposed one on either side of the slot. The end of the plug element may be lapped in a transverse direction with respect to said slot to define within the slot two pins lying in a pin plane of the plug element, in each of which pin is received one of said spring terminals. Optionally, the body and plug element are injection moulded from plastics material.

In a preferred embodiment, the body and plug element are separate components, the body comprising a sleeve having a sleeve axis that coincides with said bore axis when the plug is inserted in a socket, through which sleeve the lighting wire extends, the sleeve also receiving a connection member of the plug element to connect the plug element and sleeve together. The connection member may comprise two resilient prongs extending from the plug element and having dogs at their ends, said prongs being adapted to spring said dogs outwardly from said sleeve axis into corresponding lugs in the side of the sleeve when pressed together towards said sleeve axis and inserted axially into said sleeve. Said prongs are preferably in a prong plane containing said sleeve axis and orthogonal with respect to said pin plane.

In a further preferred embodiment, the plug element has fins adapted to slide in axially aligned grooves in the bore of the sleeve to orientate the plug element about the sleeve axis with respect to the sleeve. The plug element may also have a detent adapted to be received in a corresponding notch in the sleeve preventing full interengagement of the plug element in the sleeve unless the plug element is correctly orientated about the sleeve axis with respect to the sleeve. Preferably, the pins are on a front of the plug element, two pin bores being defined in a rear of the plug element and extending into each pin, said spring terminals being received in said pin bores. Each pin may further include a pin slot orthogonal said board slot and extending into each pin from opposite sides of each pin to intersect the pin bore of each pin, whereby an internal latch is formed in each bore to receive a catch of said spring terminal and retain the spring terminal when inserted in the pin bore.

In another preferred embodiment, each spring terminal comprises a spring leaf crimped to a respective conductor of the lighting wire and formed into a U-shape having a crimp U-arm and a contact U-arm, the crimp U-arm being connected to said conductor and the other contact U-arm being provided with a return arm, the transition between the contact U-arm and return arm of one spring terminal being arranged to face the corresponding transition of the other spring terminal so as to resiliently clamp the board between them when the plug is inserted in a socket. Preferably: each return arm is adapted to bear against an inside of the crimp U-arm and serves to resiliently support the contact U-arm during deflection thereof on insertion of the plug into a socket; and/or the crimp U-arm has a width greater than the width of said pin slot and has said catch formed by a barb of the crimp U-arm pressed out of the plane of the crimp U-arm, which barb has a width less than the width of said pin slot so that the barb snaps into the pin slot behind said latch when the terminal is first inserted into the pin bore.

In a still further preferred embodiment, the housing comprises a base clamshell and a top clamshell that meet and are retained edge to edge, the top clamshell having side walls that extend from a top wall and the base clamshell having side walls that extend from a base wall. Preferably, sidewalls of each clamshell have C-shaped slots in the edges which between respective facing edges of the clamshells define a socket opening, upstanding flanges from the base and top walls defining sides of the socket. Preferably; said C-shaped slots combine to form said socket opening as a circular opening with a flat on one side, said plug having a corresponding circular cross section with a corresponding flat along its length that is inserted in said socket; and/or said flanges are stepped at a distance from the opening to receive and locate the circuit board. Said flanges may also extend under and over the board and be inclined inwardly on either side of the bore axis to define receptacles to closely receive sides of said pins above and below the board. Preferably, the diameter of the socket opening is less than 10 mm.

Said base clamshell may comprise a rear end and a front end, the rear end comprising upstanding cable flanges from the base wall that have recesses to define a labyrinthine path to receive said mains cable and provide strain relief thereto. Preferably, said paths are defined for a second mains cable to permit mains electricity to be looped into the unit. Said paths may be curved in opposite senses around a boss to receive a screw for securing said top clamshell to said base clamshell.

Preferably, the top clamshell is in two parts being a front end part and a rear end part, wherein the front end part comprises a hook at a front end of the front end part to engage a rail on a front end of the base clamshell and a pair of catches at a rear end of the front end part to engage in apertures in the base clamshell. The rear end part of the top clamshell preferably overlaps the rear end of the front end part of the top clamshell and is secured to the base clamshell by a screw, whereby the unit cannot be dismantled except by removing the screw.

In a further preferred embodiment, the live track of the circuit board is provided with a fuse to protect the unit in the event of overload. The overload current that blows the fuse is preferably less than 500 milliamps.

Preferably, said terminal box has a depth in the range 16 mm to 20 mm. Said terminal box may also comprise a number of sockets, wherein the number is in the range four to twenty. Said terminal box may have a width in the range 30 mm to 50 mm. Said terminal box may have a length in the range 60 mm to 100 mm. Said plug preferably has a substantially circular cross-section and has a diameter in the range of 8 mm to 12 mm.

In accordance with a second aspect of the invention there is provided terminal box for use in the distribution unit of the first aspect of the invention, comprising:
a) a housing having an opening for a wire carrying mains electricity;
b) a circuit board having terminals for connection of live and neutral conductors of said wire;
c) at least two conductive tracks on the surface of said circuit board each connecting to a respective one of said terminals; and
d) a plurality of sockets in the housing, each having a non-circular bore with a longitudinal bore axis, the bore intersecting the edge of the circuit board, wherein the tracks are not closer than 3 mm to the edge of the circuit board where a socket intersects the circuit board.

Preferably said tracks are disposed on opposite sides of the circuit board.

In a further preferred embodiment of the second aspect of the invention, the terminal box further comprises the features of the terminal box described in relation to the first aspect of the invention.

In a third aspect of the invention, there is provided a plug for use in the distribution unit according to the first aspect of the invention, comprising:
a) a body having a non-circular cross-section;
b) a lighting wire connected for connection to an LED lighting element; and
c) a plug element on the end of the body and including two spring terminals, one connected to each of a live and neutral conductor of the lighting element.

In a preferred embodiment, the plug further comprises the features of the plug described in relation to the first aspect of the invention.

### BRIEF DESCRIPTION OF THE DRAWINGS

Embodiments of the invention are further described hereinafter, by way of example, with reference to the accompanying drawings, in which:

FIG. 1 is a perspective view of a distribution unit according to the present invention;

FIG. 2 is an exploded view of a terminal box for use in a distribution unit according to the present invention;

FIG. 3a is a perspective view of a plug for use in a distribution unit according to the present invention;

FIG. 3b is an exploded view of a plug for use in a distribution unit according to the present invention;

FIG. 4 is a cross-sectional view of a plug for use in a distribution unit according to the present invention;

FIG. 5 is a perspective view of spring terminals for use in a plug for use in a distribution unit according to the present invention;

FIG. 6 is a rear-end perspective view of a plug element for a plug for use in a distribution unit according to the present invention;

FIG. 7 is a front view of the plug element of FIG. 6 showing planes for FIGS. 7a, b and c;

FIG. 7a is a cross-sectional view through the plug element of FIG. 7;

FIG. 7b is a cross-sectional view through the plug element of FIG. 7;

FIG. 7c is a cross-sectional view through the plug element of FIG. 7; and

FIG. 8 is a perspective view of an assembled distribution unit according to the present invention.

### DETAILED DESCRIPTION

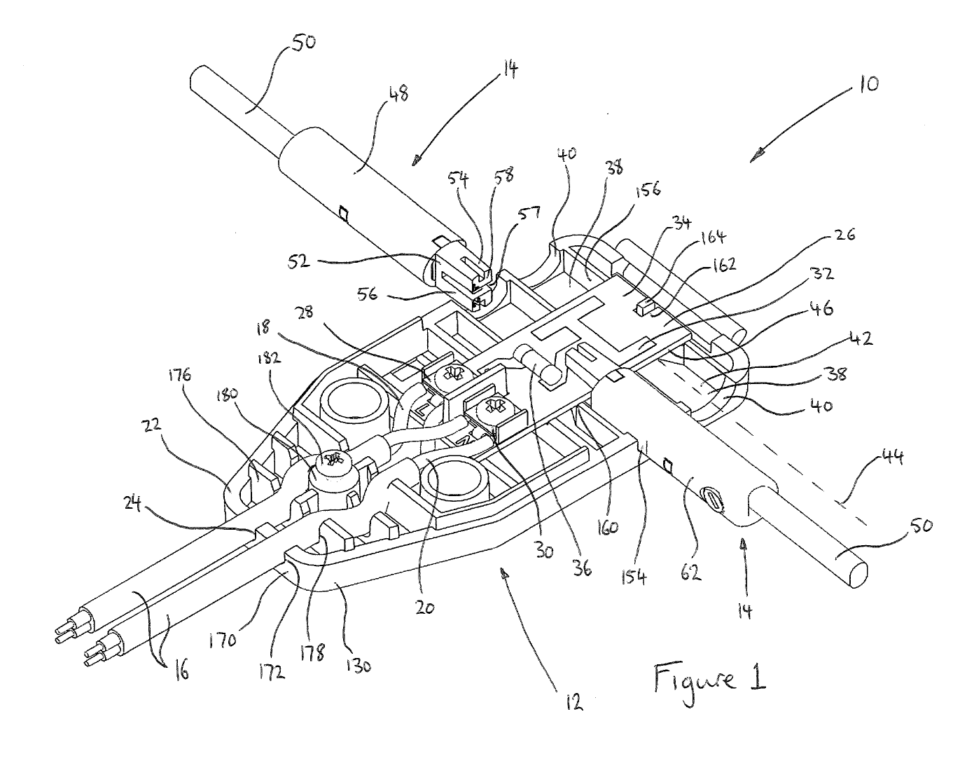

In FIG. 1 a distribution unit 10 for distributing mains electricity to multiple LED lighting devices is shown. The distribution unit comprises a terminal box 12 and one or more plugs 14, each adapted for connection to individual LED lighting elements (not shown). The terminal box 12 is adapted for connection to mains electricity and to receive the plugs 14. The mains electricity is carried by a wire 16 having live 18 and neutral 20 conductors.

The terminal box has a housing 22 with a mains opening 24 for the wire 16. A circuit board 26 has terminals 28, 30 for connection to the live 18 and neutral 20 conductors respectively. The circuit board 26 also comprises at least two conductive tracks 32 one on a topside surface 34 of the circuit board 26 and the other on a bottom side (not visible). Each conductive track is connected to one of the terminals 28, 30. The topside conductor 32 is connected to the live terminal 28 through a fuse 36 that is soldered direct onto the board. It could be arranged as a replaceable fuse if appropriate receptor terminals (not shown) are provided on the board 26. The housing 22 further comprises a plurality of sockets 38. Each socket has a non-circular opening 40 and a bore 42 with a longitudinal bore axis 44 so that the bore 42 of the socket intersects the edge 46 of the circuit board 26 along the bore axis 44.

Each plug 14 comprises a body 48 having a cross-sectional shape that corresponds to the opening 40 of the sockets 38. The corresponding shapes permit insertion of the plug 14 into the socket 38 in only one orientation of the body with respect to the socket about the bore axis 44. The plug further comprises a lighting wire 50 extending from the body 48 and for connection to one of the LED lighting devices. A plug element 52 is positioned at the opposite end of the body to the wire and includes a live plug pin 54 and a neutral plug pin 56, arranged with a board slot 57 which is able to receive the edge 46 of the board 26. The plug element has a front end 58 and a rear end (not visible) wherein the plug pins are positioned at the front end.

In connection of the plug and the housing, the plug 14 is inserted into the socket 38 of the housing 22 along the bore axis 44 so that the plug pins 54, 56 engage with the edge 46 of the circuit board 26. On further movement of the plug 14 along the bore axis 44 and toward the circuit board 26, the live pin 54 and the neutral pin 56 engage with the live conductive track 32 and the neutral conductive track (not shown) respectively.

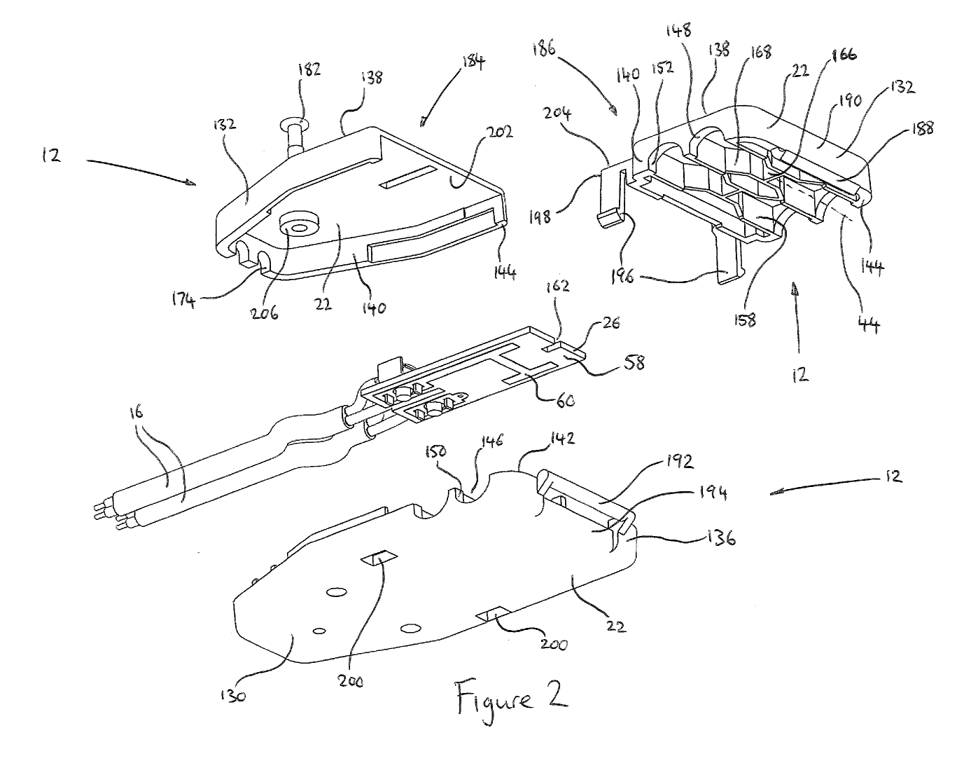

FIG. 2 shows the underside surface 58 of the circuit board 26. The embodiment shown in this Figure is such that the live and neutral conductive tracks are disposed on opposite surfaces/sides of the circuit board. In the embodiment shown, the neutral track 60 is disposed on the underside surface 58 of the circuit board. As previously mentioned, the live track 32 is disposed on the topside surface 34.

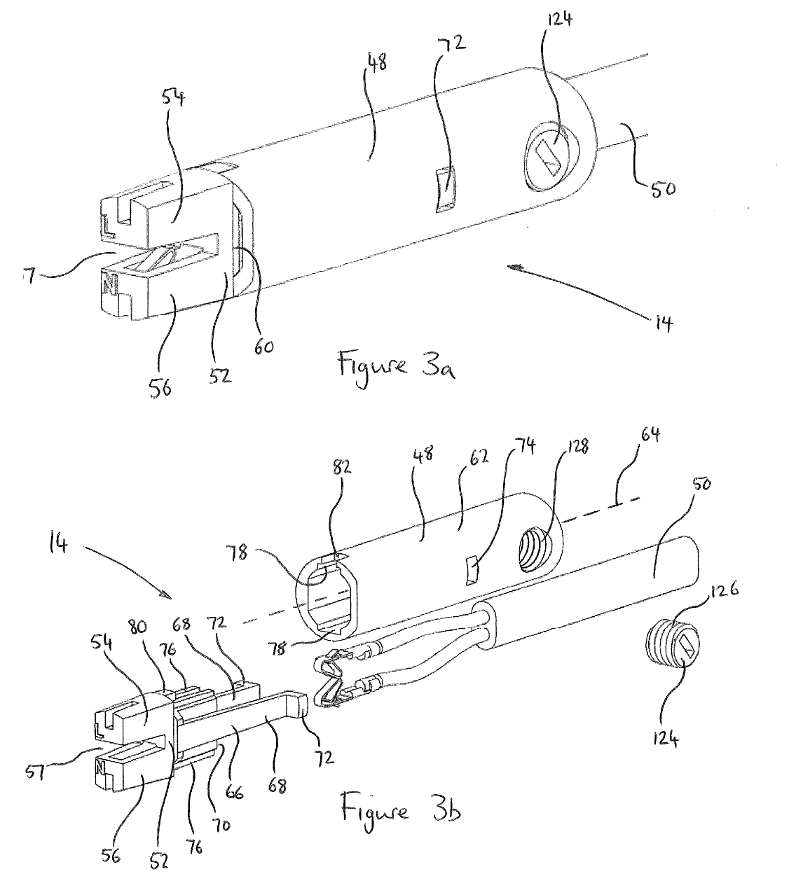

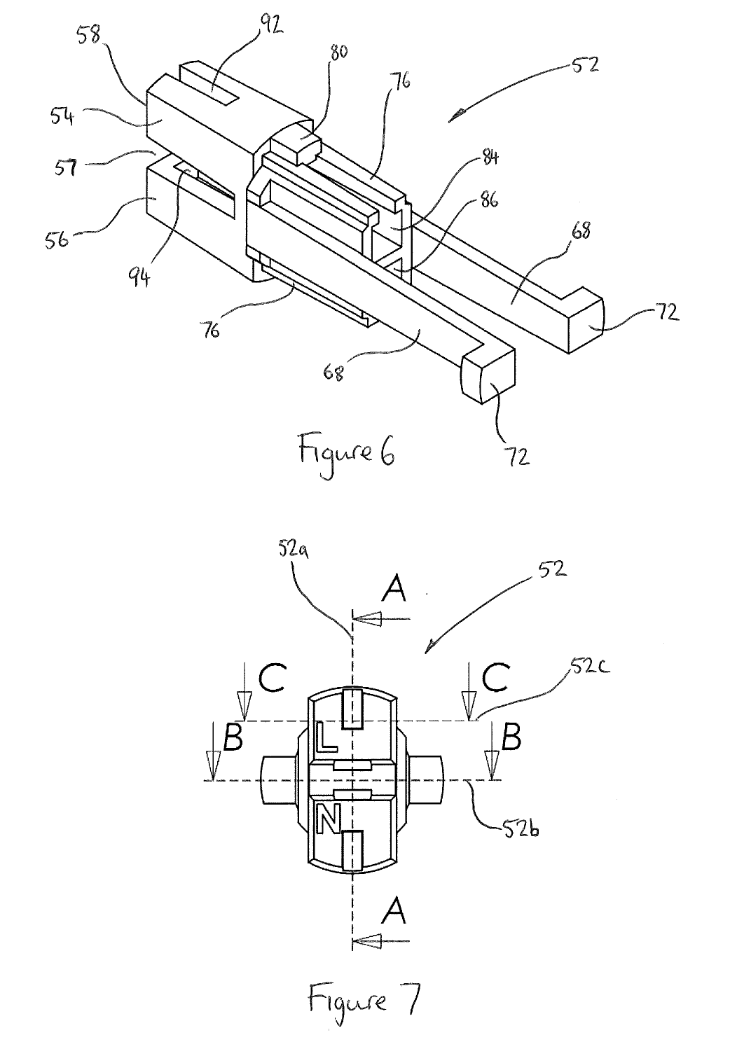

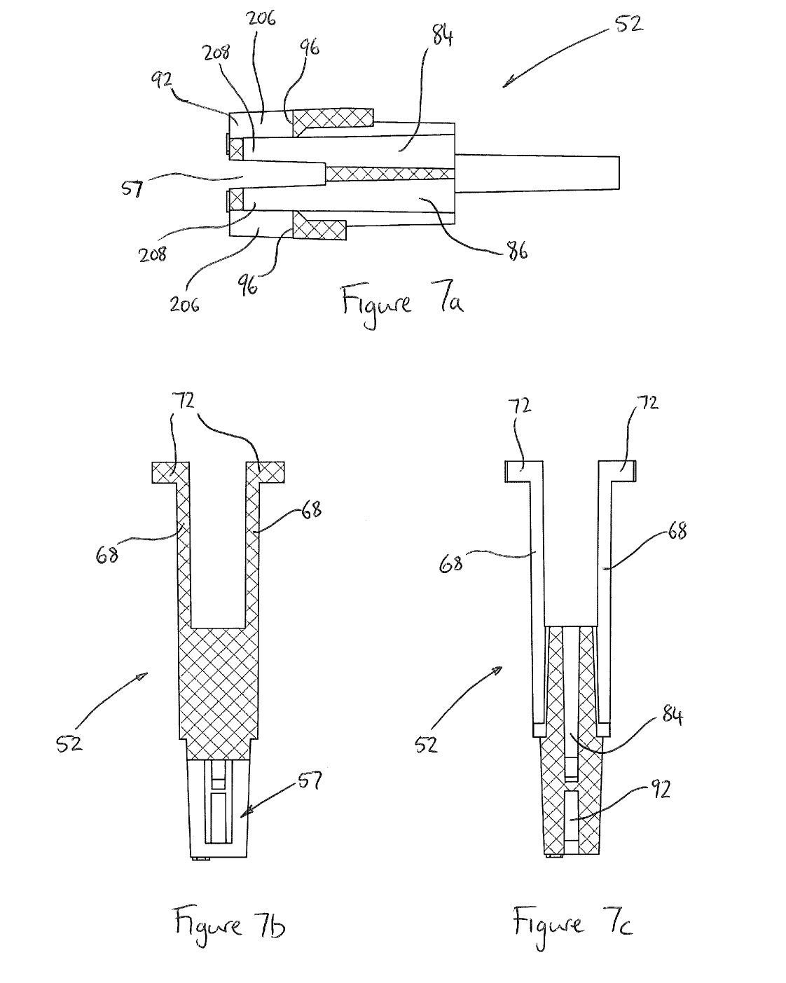

FIG. 3a shows the plug 14 in its assembled configuration and FIG. 3b shows the plug 14 in its pre-assembled or disassembled configuration. The following text references are made to FIGS. 3a and 3b where appropriate. As previously mentioned, the plug comprises the body 48, the plug element 52 with the board slot 57, and the lighting wire 50. The plug element is lapped 60 in a transverse direction to said slot 57 to define the two pins 54, 56 which lie in a pin plane (see 52a, FIG. 7).

The body 48 and the plug element 52 can be injection moulded from a plastic material. FIG. 3b shows the body and the plug element to be separate components. The body has a sleeve 62 that has a sleeve axis 64 corresponding with the bore axis 44 when the plug 14 is inserted into a socket 38. The lighting wire 50 extends through the sleeve 62 about the sleeve axis 64. The sleeve and the plug element are connected together by a connection member 66 of the plug element 52.

The connection member 66 comprises two resilient prongs 68 extending from the plug element 52 at the rear end 70 thereof. The resilient prongs have dogs 72 at the end thereof adapted to fit into lugs 74 of the sleeve 62. On assembly of the plug element 52 with the sleeve 62, the resilient prongs 68 are pressed inwardly toward the sleeve axis 64 and the plug element 52 inserted into the sleeve 62. At the point when the plug element 52 is correctly inserted into the sleeve 62, the resilient prongs 68 spring outwardly from the sleeve axis 64 and push the dogs 72 into the lugs 74. The prongs 68 are positioned in a prong plane (see 52b, FIG. 7) which is orthogonal to the pin plane (see 52a, FIG. 7).

Further assurance of correct insertion of the plug element 52 into the sleeve 62 is provided by fins 76 on the plug element adapted to slide in axially-aligned grooves 78 on the inside of the sleeve 62. A detent 80 is also provided on the plug element 52 to be received in a corresponding notch 82 in the sleeve 62. The notch 82 prevents full interengagement of the plug element 52 in the sleeve 62 unless the plug element is correctly orientated about the sleeve axis 64 with respect to the sleeve. The fins 76 above and below the sleeve axis 64 could also be individually shaped with corresponding individually shaped grooves 78 above and below the sleeve axis 64 to prevent full interengagement of the plug element in the sleeve unless the plug element is correctly orientated about the sleeve axis with respect to the sleeve

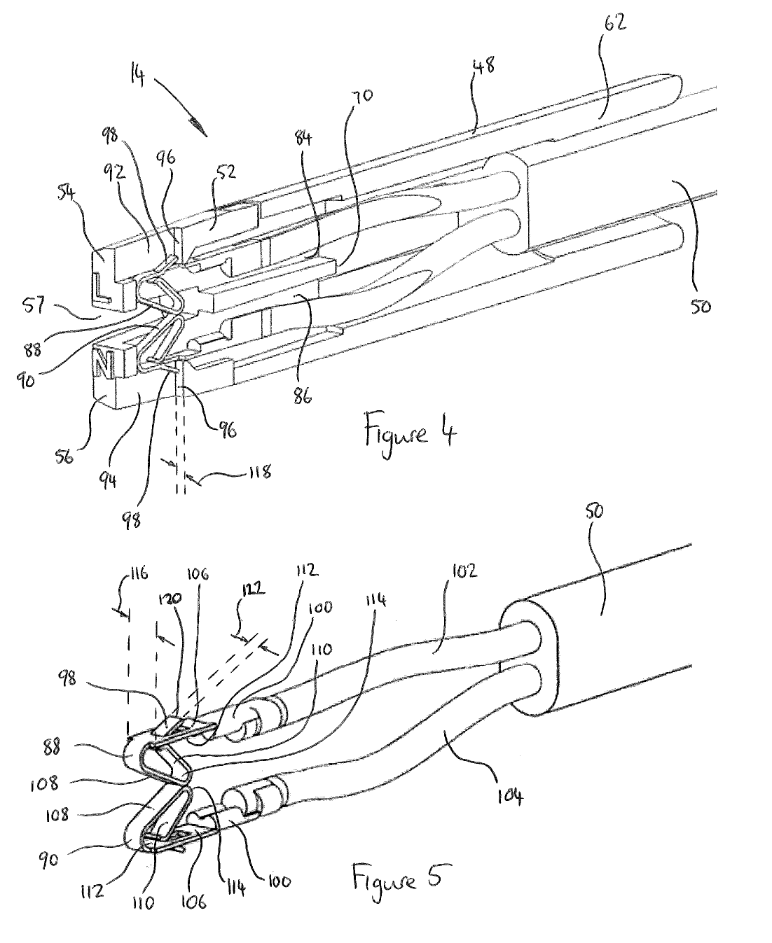

FIG. 4 shows that the plug element 14 has a live pin bore 84 and a neutral pin bore 86, opening at the rear 70 of the plug element. The live pin bore 84 extends into the live pin 54 and the neutral pin bore 86 extends into the neutral pin 56, so that a live spring terminal 88 is received in the live pin bore 84 and positioned in the live pin 54, and a neutral spring terminal 90 is received in the neutral pin bore 86 and positioned in the neutral pin 56. The spring terminals 88, 90 are therefore positioned on either side of the board slot 57 so that when the circuit board 26 (see FIGS. 1 and 2) is positioned inside the board slot 57, the live spring terminal 88, housed within the live pin 54, contacts the live conductive track 32 and the neutral spring terminal 90, housed within the neutral pin 56, contacts the neutral conductive track 60.

The pins 54, 56 have pin slots 92, 94 orthogonal to the pin bores 84, 86 and extending into each pin from opposite sides thereof to intersect the pin bore. An internal latch (or ledge) 96 is formed by each slot and receives a catch 98 of the spring terminals 88, 90. The catch 98 retains the spring terminals when they are inserted into the pin bores 84, 86.

FIG. 5 shows each of the terminals to comprise a spring leaf 100 crimped to one of a live 102 or neutral 104 conductors of the lighting wire 50. The spring leaf 100 is formed into a shape having a crimp U-arm 106, crimped to the conductor 102, 104, and a contact U-arm 108 for contact with said conductive tracks 32, 60. The contact U-arm 108 is further provided with a return arm 110 that bears against the inside 112 of the crimp U-arm 106 and serves to resiliently support the contact U-arm 108. The transition 114 between the contact U-arm 108 and return arm 110 of the live spring terminal 88, is arranged to face the corresponding transition 114 of the neutral spring terminal 90. This arrangement serves to provide the resilience of the spring terminals to resiliently clamp the board 26 when the plug element 52 is inserted into the socket 38 and onto the board 26.

With reference to FIGS. 4 and 5, the inside 112 of the crimp U-arm 106 has a width 116 that is greater than the width 118 of the pin slot 92, 94 and thus prevents the crimp U-arm 106 from entering the pin slots. The catch 98 is formed by a barb 120 pressed out of the plane of the crimp U-arm 106. The barb therefore has a width 122 which is less than the width 118 of the pin slots 92, 94. On insertion of the spring terminals 88, 90 into the pin bores 84, 86, the barbs 120 of the catches 98 snap into the pin slots 92, 94 behind the latches 96 and the spring terminals are retained in the plug element.

Returning to FIG. 3b, the sleeve 62 of the plug 14 may also have a gripping means 124 for gripping the lighting wire 50. FIG. 3b shows the gripping means as a grub screw 126, which is screwed into a tapped hole 128 to apply pressure to a portion of the lighting wire 50 inside the sleeve against an inside surface of the sleeve opposing the tapped hole 128, thus clamping the wire 50.

FIGS. 1 and 2 further show the housing 22 of the terminal box 12. The housing of the terminal box comprises a base clamshell 130 and a top clamshell 132. The base clamshell has a base wall 134 and side walls 136 that extend from the base wall 134. The top clamshell 132 has a top wall 138 and side walls 140 that extend from the top wall. Edges 142, 144 of the base clamshell 130 and the top clamshell 132 meet when the two clamshells are brought together to form the housing 12. Each of the side walls of the clamshells has opposing C-shaped slots 146, 148 that when brought together combine to define the opening 40 of the socket 38. The opening of the socket is therefore circular but has a flattened side formed by flattened portions 150, 152 of the C-shaped slots 146, 148. The flattened portion creates the non-circular opening 40 which corresponds to a flattened portion 154 along at least part of the length of the outside of the sleeve 62 of the plug 14.

Referring in part to FIGS. 1 and 2, the clamshells further comprise upstanding flanges 156, 158 to form sides of the bore 42 of the socket 38. The flanges 156 upstanding from the base clamshell 130, and optionally those from the top clamshell, are stepped at a distance from the opening defined by the C-shaped slot 146, 148. The step 160 in the flanges 156 provides a receptacle for the circuit board 26. The circuit board can additionally comprise a notch 162 to receive a detent 164 upstanding from the base clamshell 130. The distance of the edge of the circuit board, and therefore the step, from the opening is preferably greater than 10 mm to provide a safe depth from the opening of the conductive tracks 32, 60 in the sockets 38. The arrangement of the flanges is substantially similar for the base and the top clamshells and therefore the further features of the flanges are described in relation to the top clamshell of FIG. 2 only. The flanges 158 are inclined inwardly on either side of the bore axis 44 to define receptacles 166 that closely receive sides of the pins 54, 56. The inward incline 168 therefore preferably begins at a position adjacent to the edge of the board to define the receptacles 166 over the conductive tracks 32, 60.

As mentioned above, in reference to FIG. 1, the housing has a mains opening 24 for the wire 16 carrying mains electricity at a rear end 170 of the housing 12. The mains opening 24 is defined by the mating of a C-shaped slot 172 on the base clamshell and a corresponding C-shaped slot 174 on the top clamshell (see FIG. 2). Upstanding cable flanges 176 extend from the base wall of the base clamshell 130 and have recesses 178 to receive and channel the mains cable 16. The recesses 178 are positioned so that the cable 16 takes a labyrinthine path to provide strain relief against a force trying to remove the cable 16 from the housing 12. The path is defined to curve around a boss 180 that receives a screw 182 for fixing the top and base clamshells 132, 130 together. Two openings and two paths can be formed to take curved paths around opposing sides of the boss so that the terminal box 12 can receive two cables 16, as shown. This permits the distribution unit to be connected to an electricity loop.

Referring to FIG. 2, the top clamshell 132 is shown to comprise two parts, a rear end part 184 and a front end part 186. The front end part 186 has a hook 188 at a front end 190 thereof which engages with a rail 192 on a front end 194 of the base clamshell 130. The front end part 186 further has a pair of resilient catches 196 at a rear end 198 of the front end part to engage with apertures 200 in the base clamshell 130. The rear end part 184 also comprises an overlapping portion 202 that overlaps an underlying portion 204 of the front end part. The rear end part comprises a screw bore 206 that journals the screw 182 into the boss 180 in the bass clamshell 130.

With reference to FIGS. 1 and 2, on assembly of the terminal box 12, the circuit board 26 is first positioned in the base clamshell 130 between the steps 160 in the upstanding flanges 156 and the notch 162 positioned about the detent 164. The hook 188 of the front end part 186 is then hooked onto the rail 192 of the base clamshell 130 and the catches 196 are pressed into engagement with apertures 200 in the base clamshell. Assembly of the rear end part 184 with the pre-assembled front end part 186 and base clamshell 130 is performed by lining up the parts and screwing the screw 182 into the boss 180. The overlapping portion 202 of the rear end part 184 traps the underlying portion 204 of the front end part 186 so that the housing cannot be dismantled except by removing the screw 182. The terminal box 12 is distributable in this assembled configuration.

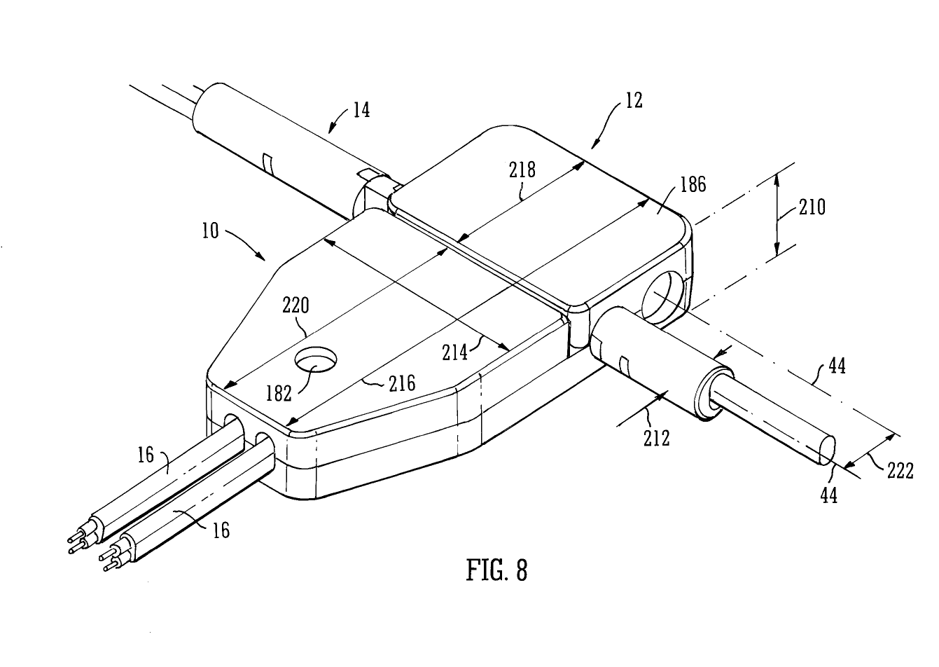

To enable the connection of the terminal box to an isolated mains electricity wire or wires 16, the screw 182 is unscrewed and the rear end part 184 removed from the base clamshell 130. The live 18 and neutral 20 parts of the mains supply can then be connected to the terminals 28, 30. The rear end part 184 of the top clamshell is then replaced onto the housing and the screw 182 screwed into the boss 180. The mains electricity wire 16 can then be connected to the mains supply and the distribution unit 10 made live. The assembled distribution unit 10 is shown in FIG. 8.

Returning to FIG. 1, the fuse 36 protects the unit in the event of overload. The LED lights attached to the distribution unit are low current devices and accordingly, the fuse is preferably rated at 500 milliamps.

The housing 12, or parts thereof, as described hereinbefore can be moulded from plastic by injection moulding or similar. The aforementioned features in the base clamshell 130 are arranged such that the base clamshell 130 can be moulded in a die with two opposing sides. Likewise, the rear end and front end parts 184, 186 of the top clamshell 132 can be formed by injection moulding in a die with two opposing sides. Therefore the cost of manufacturing of these parts is minimised.

The plug sleeve 62 can be moulded using injection moulding using a die having a core insert to define the inside of the sleeve. Other core inserts can be used to define the lugs 74 and the hole 128 which is either tapped after moulding or formed as a tapped hole by a screw core.

The plug element can be injection moulded using a die having two sides. FIG. 6 shows the plug element 52 from the rear end 70 thereof and shows the resilient prongs 68, the dogs 72, the pin bores 84, 86, the pin slots 92, 94, the fins 76 and the detent 80.

Injection moulding of the plug element 52 can be performed using a die having two sides, the first side approaching from the front end 58 of the plug element 52 and the second side approaching from the rear end of the plug element 52.

FIG. 7 illustrates the planes of the illustrations shown in FIGS. 7a, b and c. FIG. 7a is a midline plane taken at A-A 52a and corresponding to the pin plane. FIG. 7b is taken at B-B 52b along the prong plane. FIG. 7c is taken at C-C 52c along a plane parallel to B-B 52b and offset therefrom. FIGS. 7a, b and c therefore show the cross-sectional configurations of the plug element 52 to permit two-piece injection moulding. The first side of the die as mentioned above therefore comprises a profile adapted to form the board slot 57, the upper part of the pin slot 206 and the latches 96. The profile of the first side of the die further forms the front side of the resilient prongs 68 and the dogs 72. The second side of the die mentioned above comprises a profile adapted to form the rear side of the prongs 68 and the dogs 72, and to form the pin bores 84, 86 and the lower part of the pin slot 208. The edges of the plug element which are substantially perpendicular to the sides of the die are tapered to enable easy removal of the plug element from the die.

The aforementioned embodiments enable the distribution unit 10 to be small. With reference to FIG. 8, the terminal box 12 has a depth 210 less than 20 mm, preferably less than 15 mm. The plugs 14 have a diameter 212 of less than 10 mm. The terminal box further has a width 214 less than 40 mm and a length 216 less than 80 mm. The front part 186 of the top clamshell 132 of the housing 12 has a length 218 less than 30 mm. The rear part 184 of the top clamshell 132 of the housing 12 has a length 220 less than 50 mm. Each socket 38 is separated by 2 mm and there is therefore a socket separation distance 222 of only 12 mm between the bore axis 44 of each socket. The configuration shown in FIG. 8 comprises four sockets 38, two on each side of the terminal box 12. It is within the scope of the invention to have many more sockets 38, each additional pair increasing the length of the terminal box 12 by 12 mm. For example, there could be eight, twelve or twenty sockets.

The small nature of the distribution unit 10 is provided by the placement of the conductive tracks 32, 60 on opposing sides of the circuit board 26. Electrical regulations determine that there must be a minimum surface distance between conductive elements. The conductive tracks 32, 60 of the circuit board 26 are positioned at least 3 mm from the edge 46 of the board. Therefore, with a thickness of the board of 1 mm to 2 mm, there is at least 7 mm to 8 mm between the conductive tracks and the board, and in turn the distribution unit, therefore meets the electrical regulations. The edge 46 of the circuit board is recessed 10 mm from the outside of the housing 22. Therefore, the conductive tracks 32, 60 are positioned at least 13 mm from the outside of the housing 22. Access to the conductive tracks by unwanted objects is further limited by the inclines 168 and the receptacles 166 formed by the upstanding flanges 158.

As hereinbefore mentioned, the plug pins 54, 56 engage the spring terminals 32, 60 when the plug 14 is inserted into the socket 38 and board slot 57 engages the board 26. The movement of the plug 14 from the edge of the board is determined by the aforementioned measurements. In a particular example, the plug 14 is plugged into the socket 38 and moved along the bore axis 44 by 10 mm. At this point, the front end of the plug element 52 is adjacent to the edge 46 of the board. The plug 14 is then moved further by at least 3 mm so that the spring terminals 88, 90 engage with the conductive tracks 32, 60. The spring terminals 88, 90 may be set back towards the rear of the plug element from the front thereof by 3 mm. In this arrangement, the plug is moved by 6 mm from its position adjacent the edge of the board so that the spring terminals 88, 90 engage with the conductive tracks 32, 60. The engagement of the spring terminals 88, 90 with the conductive tracks 32, 60 completes the electrical connection between the mains electricity being carried by the mains wire 16nd the light connected to the lighting wire 50.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A distribution unit for distributing mains electricity to multiple LED lighting devices, said unit comprising a terminal box and one or more plugs, the terminal box being adapted for connection to mains electricity and to receive said plugs, and each plug being adapted for connection to individual LED lighting elements, wherein said terminal box comprises:
a) a housing having an opening for a distribution wire carrying mains electricity;
b) a circuit board having terminals for connection of live and neutral conductors of said wire;
c) at least two conductive tracks on the surface of said circuit board each connecting to a respective one of said terminals; and
d) a plurality of sockets in the housing each having a non-circular bore with a longitudinal bore axis, the bore intersecting the edge of the circuit board,
wherein said tracks are not closer than 3 mm to the edge of the circuit board where a socket intersects the circuit board, and
wherein each said plug comprises:
a) a body having a cross-section corresponding with the bore of each socket whereby the body can be inserted into the socket in only one orientation of the body with respect to the socket about said bore axis;
b) a lighting wire for connection to an LED lighting element extending from the body; and
c) a plug element on the end of the body and including two spring terminals, one connected to each of a live and neutral conductor of the lighting wire, wherein the plug element engages with the edge of the circuit board when the plug is inserted in a socket by movement along said axis and, on further movement of the plug into the socket by more than the distance of said tracks to the edge of the circuit board, said spring terminals engage a respective one of said tracks to complete electrical connection with the mains electricity.

2. A distribution unit as claimed in claim 1, in which said live and neutral tracks are disposed on opposite sides of the board and said plug element includes a board slot to receive the edge of the board, said terminals being disposed one on either side of the slot.

3. A distribution unit as claimed in claim 2, in which the end of the plug element is lapped in a transverse direction with respect to said slot to define two pins lying in a pin plane of the plug element, in each of which pin is received one of said spring terminals.

4. (canceled)

5. (canceled)

6. (canceled)

7. (canceled)

8. (canceled)

9. (canceled)

10. (canceled)

11. (canceled)

12. A distribution unit as claimed in claim 2, in which each spring terminal comprises a spring leaf crimped to a respective conductor of the lighting wire and formed into a U-shape having a crimp U-arm and a contact U-arm, the crimp U-arm being connected to said conductor and the other contact U-arm being provided with a return arm, the transition between the contact U-arm and return arm of one spring terminal being arranged to face the corresponding transition of the other spring terminal so as to resiliently clamp the board between them when the plug is inserted in a socket.

13. A distribution unit as claimed in claim 12, in which each return arm is adapted to bear against an inside of the crimp U-arm and serves to resiliently support the contact U-arm during deflection thereof on insertion of the plug into a socket.

14. A distribution unit as claimed in claim 12, in which:
the end of the plug element is lapped in a traverse direction with respect to said slot to define two pins lying in a pin plane of the plug element, in each of which pin is received one of said spring terminals,
in which each pin includes a pin slot orthogonal said board slot and extending into each pin from opposite sides of each pin to intersect the pin bore of each pin, whereby an internal latch is formed in each bore to receive a catch of said spring terminal and retain the spring terminal when inserted in the pin bore, and,
the crimp U-arm has a width greater than the width of said pin slot and has said catch formed by a barb of the crimp U-arm pressed out of the plane of the crimp U-arm, which barb has a width less than the width of said pin slot so that the barb snaps into the pin slot behind said latch when the terminal is first inserted into the pin bore.

15. (canceled)

16. A distribution unit as claimed in claim 1, in which the housing comprises a base clamshell and a top clamshell that meet and are retained edge to edge, the top clamshell having side walls that extend from a top wall and the base clamshell having side walls that extend from a base wall.

17. A distribution unit as claimed in claim 16, in which sidewalls of each clamshell have C-shaped slots in the edges which between respective facing edges of the clamshells define a socket opening, upstanding flanges from the base and top walls defining sides of the socket.

18. (canceled)

19. (canceled)

20. A distribution unit as claimed in claim 17, in which the end of the plug element is lapped in a transverse direction with respect to said slot to define two pins lying in a pin plane of the plug element, in each of which pin is received one of said spring terminals, and in which said flanges extend under and over the board and are inclined inwardly on either side of the bore axis to define receptacles to closely receive sides of said pins above and below the board.

21. (canceled)

22. (canceled)

23. (canceled)

24. A distribution unit as claimed in claim 16, in which the top clamshell is in two parts being a front end part and a rear end part, wherein the front end part comprises a hook at a front end of the front end part to engage a rail on a front end of the base clamshell and a pair of catches at a rear end of the front end part to engage in apertures in the base clamshell.

25. A distribution unit as claimed in claim 24, in which the rear end part of the top clamshell overlaps the rear end of the front end part of the top clamshell and is secured to the base clamshell by a screw, whereby the unit cannot be dismantled except by removing the screw.

26. A distribution unit as claimed in claim 1, in which the live track of the circuit board is provided with a fuse to protect the unit in the event of overload.

27. (canceled)

28. (canceled)

29. (canceled)

30. (canceled)

31. A distribution unit as claimed in claim 1, any of the preceding claims wherein said terminal box comprises a number of sockets, wherein the number is in the range four to twenty.

32. A terminal box for use in the distribution unit of claim 1, comprising:
a housing having an opening for a wire carrying mains electricity;
a circuit board having terminals for connection of live and neutral conductors of said wire;
at least two conductive tracks on the surface of said circuit board each connecting to a respective one of said terminals; and
a plurality of sockets in the housing, each having a non-circular bore with a longitudinal bore axis, the bore intersecting the edge of the circuit board,
wherein the tracks are not closer than 3 mm to the edge of the circuit board where a socket intersects the circuit board.

33. A terminal box as claimed in claim 32, wherein said tracks are disposed on opposite sides of the circuit board.

34. (canceled)

35. A plug for use in the distribution unit of claim 1, comprising:
a body having a non-circular cross-section;
a lighting wire connected for connection to an LED lighting element; and
a plug element on the end of the body and including two spring terminals, one connected to each of a live and neutral conductor of the lighting element.

36. A plug as claimed in claim 35, in which plug element includes a board slot to receive the edge of the board, said terminals being disposed one on either side of the slot.

37. (canceled)

38. (canceled)

39. (canceled)

40. A plug as claimed in claim 36, in which the end of the plug element is lapped in a transverse direction with respect to said slot to define two pins lying in a pin plane of the plug element, in each of which pin is received one of said spring terminals.

41. A plug as claimed in claim 40, in which the body and plug element are injection molded from plastics material.

42. A plug as claimed in claim 41, in which the body and plug element are separate components, the body comprising a sleeve having a sleeve axis that coincides with said bore axis when the plug is inserted in a socket, through which sleeve the lighting wire extends, the sleeve also receiving a connection member of the plug element to connect the plug element and sleeve together.

43. A plug as claimed in claim 42, in which said connection member comprises two resilient prongs extending from the plug element and having dogs at their ends, said prongs being adapted to spring said dogs outwardly from said sleeve axis into corresponding lugs in the side of the sleeve when pressed together towards said sleeve axis and inserted axially into said sleeve.

44. A plug as claimed in claim 43, in which said prongs are in a prong plane containing said sleeve axis and orthogonal with respect to said pin plane.

45. A plug as claimed in claim 44, in which the plug element has fins adapted to slide in axially aligned grooves in the bore of the sleeve to orientate the plug element about the sleeve axis with respect to the sleeve.

46. A plug as claimed in claim 44, in which the plug element has a detent adapted to be received in a corresponding notch in the sleeve prevent full interengagement of the plug element in the sleeve unless the plug element is correctly orientated about the sleeve axis with respect to the sleeve.

47. A plug as claimed in claim 40, in which the pins are on a front of the plug element, two pin bores being defined in a rear of the plug element and extending into each pin, said spring terminals being received in said pin bores.

48. A plug as claimed in claim 47, in which each pin includes a pin slot orthogonal said board slot and extending into each pin from opposite sides of each pin to intersect the pin bore of each pin, whereby an internal latch is formed in each bore to receive a catch of said spring terminal and retain the spring terminal when inserted in the pin bore.

49. A plug as claimed in claim 36, in which each spring terminal comprises a spring leaf crimped to a respective conductor of the lighting wire and formed into a U-shape having a crimp U-arm and a contact U-arm, the crimp U-arm being connected to said conductor and the other contact U-arm being provided with a return arm, the transition between the contact U-arm and return arm of one spring terminal being arranged to face the corresponding transition of the other spring terminal so as to resiliently clamp a board between them when the plug is inserted in a socket.
